(19) United States
(12) Patent Application Publication
(10) Pub. No.: US 2012/0324077 A1
(43) Pub. Date: Dec. 20, 2012

(54) Providing Resource Accessbility During a Sleep State

(75) Inventor: Protip Roy, San Diego, CA (US)

(73) Assignee: BROADCOM CORPORATION, Irvine, CA (US)

(21) Appl. No.: 13/310,853

(22) Filed: Dec. 5, 2011

Related U.S. Application Data
(60) Provisional application No. 61/498,375, filed on Jun. 17, 2011.

(51) Int. Cl. G06F 17/30; G06F 15/173

(52) U.S. Cl. 709/223

(57) ABSTRACT

Embodiments for providing access to computing system resources, such as files, disks, flash storage and/or other resources, are disclosed. A combination network interface and storage device can be installed in a computing system, which can be configured to draw power when a host computing system is in a sleep state. A subsystem executed by the combination network interface and storage device can allow a client device to submit a request for a file stored in a storage medium accessible to the device. Additionally, the subsystem can facilitate mirroring of files from mass storage devices by the operating system and/or applications executed by the host computing system when the computing system is not in a sleep state.

### CROSS-REFERENCE TO RELATED APPLICATIONS

This application claims priority to co-pending U.S. Provisional Patent Application Ser. No. 61/498,375, filed on Jun. 17, 2011, which is hereby incorporated herein by reference in its entirety.

### BACKGROUND

Computing systems may provide network accessibility of resources such as flash storage, disks, peripherals and other devices accessible to the computing system. Network accessibility of these resources is often unavailable when the computing system is in a suspended, hibernated, standby, or other type of sleep state. Accordingly, in order to access data that is, for example, stored such resources associated with a computing system, the computing system must often be awoken, which involves powering up a processor and other resources.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 is a drawing of a combination network interface and storage device according to various embodiments of the present disclosure.

FIGS. 2-3 are drawings of a combination network interface and storage device installed in a computing system according to various embodiments of the present disclosure.

FIG. 4 is a flowchart illustrating executing of a subsystem in the combination network interface and storage device according to various embodiments of the present disclosure.

### DETAILED DESCRIPTION

Computing systems may provide network accessibility of resources such as disks, peripherals and other devices accessible to the computing system. Network accessibility of these resources is often unavailable when the computing system is in a suspended, hibernated, standby, or other type of sleep state in which a computing system can be placed. For example, a computing system can be placed into a sleep mode by an operating system after a period of inactivity. When placed in this sleep mode, in one example, a state of the system can be stored in random access memory (RAM), which can remain powered, while the computing system attempts to cut or reduce power to other devices within or accessible to the system including the hard disk drives (HDD), solid state disks (SSD), input/output (I/O) ports, and other resources. Accordingly, such a sleep mode can cause local resources of the computing system, such as a file stored on an HDD, SSD, and/or drive locally accessible to the computing system, to become unavailable via a network or other communications interface until the machine is awoken from the sleep mode. Accordingly, embodiments of the present disclosure are directed to systems and methods provide network accessibility of files when a computing system remains in a sleep state. Therefore, in the following discussion, a general description of the system and its components is provided, followed by a discussion of the operation of the same.

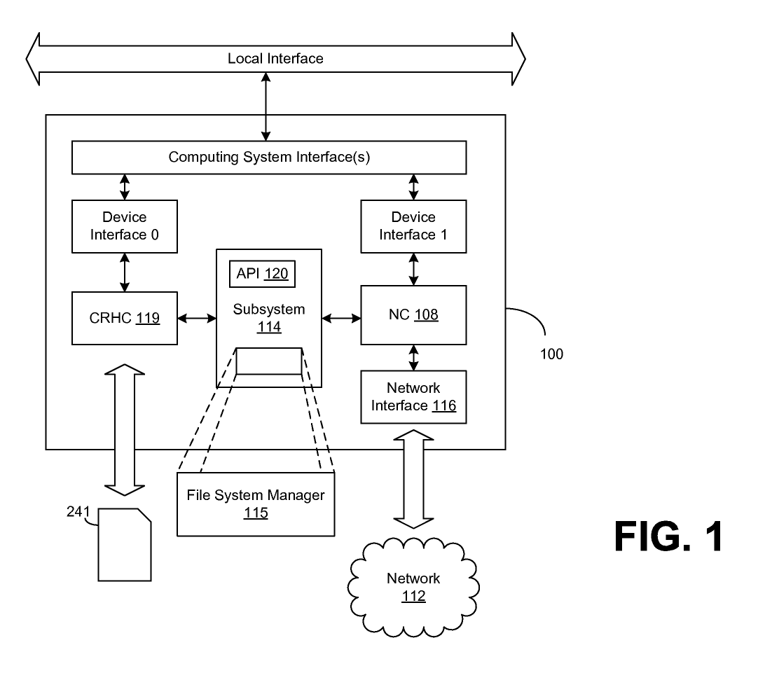

With reference to FIG. 1, shown is a combination network interface and storage device (CNIS) 100 according to various embodiments. The CNIS 100 can include a computing system interface that allows the CNIS 100 to communicate with and/or access other resources in or accessible to a computing system via a local interface. The computing system interface can include, but is not limited to, a universal serial bus (USB) interface, a peripheral component interconnect interface (PCI), a peripheral component interconnect express (PCI-E) interface, or any other interface that allows communication with or between hardware components in a computing system. The CN IS 100 can provide the functionality of a network controller 108, or network interface card, that in turn provides access to one or more networks 112. In this sense, the network controller 108 can provide network access to a computing system in which the CNIS 100 is installed. The network controller 108 can communicate with a network interface 116, which can include one or more wireless radios, antenna systems, Ethernet hardware, or any other physical interconnects or devices that can provide network capability.

The CNIS 100 can also provide the functionality of a card reader host controller (CRHC) 119. In this sense, the CRHC 119 can provide access to a computing system in which the CNIS 100 is installed to various types of storage media 241 that can be installed in a storage medium access device to which the CRHC 119 can communicate. The types of storage media 241 and card readers can vary, and can include, but are not limited to, a flash storage medium, optical storage medium, magnetic storage medium, or any other rewriteable medium as can be appreciated. In some embodiments, the CNIS 100 can be configured with on-board storage in the place of or in addition to the CRHC 119. Data can be stored in and/or accessed from the on-board storage in the same way as via a flash storage device installed in the CRHC 119. Accordingly, in the context of the present disclosure, removable storage media accessible via the CRHC 119 and/or on-board storage can be interchangeably employed.

The CNIS 100 can also include a subsystem 114 that includes logic that facilitates the various embodiments of the disclosure. The subsystem 114 can include logic that identifies whether to computing system to which the computing system interface is coupled is in a sleep mode. If the computing system is in a sleep mode, the subsystem 114 can also include logic that initiates or activates a file system manager 115 executed in the device when the computing system is in a sleep mode. The file system manager 115 configured to provide access to the file by a client device in communication over a network. The subsystem 114 can also include logic that mounts the storage medium in an operating system executed by a computing system when the computing system is not in a sleep mode.

The subsystem 114 can determine whether a computing system in which it is installed is in one or more sleep modes, which can include, but are not limited to: a suspended state, a hibernation state, and a standby state. The subsystem 114 can determine whether the computing system is in a sleep mode by attempting communication with the operating system and designating the computing system as in a sleep mode when communication with the operating system fails. In another embodiment, the subsystem 114 can determines whether the computing system is in a sleep mode by receiving a message corresponding to initiation of a sleep mode from at least one of the operating system and the computing system via the computing system interface.

Additionally, the subsystem 114 can also direct the CNIS 100 to draw power from the computing system interface when the computing system is in the sleep state so that it is operable when the computing system is in the sleep state. In other words, the drawing of power, such as an auxiliary power, from the computing system interface can allow the network controller 108 and/or CRHC 119 to continue to be in communication with one or more networks 112 and/or storage media 241, respectively, even when the computing system in which the CNIS 100 is installed is in a sleep state.

The file system manager 115 referenced above can implement a file server protocol that allows a client to access files stored on a storage media 241 accessible by the CRHC 119 even when the computing system is in a sleep state. Such a file server protocol can provide access to at least one file stored in the storage medium via the network 112 by host computer and/or a client device. Such a file server protocol can include, but is not limited to, network file system, common internet file system, server message block, file transfer protocol, or any other file server protocol that allows a client to access to files via a network 112. The subsystem 114 can also allow host systems or applications in a host computing device to access the storage media 241 via an API 120. In one embodiment, an application executed on a computing device in which the device is installed can make invoke the API to cache and/or store files in the storage media 241 for availability by a client device when the computing device is in a sleep or off state.

As one example, a media streaming and organization application executed in a host computing device can store a list of media available on a mass storage device in the computing device in the storage media 241. Accordingly, the media streaming and organization application can invoke the API to store a media list on the storage media 241. A client attempting to stream and/or download media from the computing device can be configured to request the media list from the storage media 241. In such a scenario, when the computing device is in a sleep state, the subsystem 114 can provide the media list to the client device without waking the host computing device. The subsystem 114 can also receive a request to stream and/or download media from client device. Accordingly, the subsystem 114 can be configured to issue one or more commands to wake the host computing device so that it may stream the requested media to the requesting client device. In other words, the subsystem 114 can be configured to wake the host computing device upon receiving a request associated with a file stored in the storage media 241 from a client device.

As noted above, the subsystem 114 can mount the storage medium in an operating system executed by the computing system when the computing system is not in a sleep mode. Accordingly, the subsystem 114 can provide and/or execute a driver supplied by or that is compatible with the operating system executed. The driver is configured to facilitate communication by the computing system with the card reader host controller via the computing system interface. In one non-limiting embodiment, the driver can be a universal serial bus mass storage device class driver that causes the storage medium to be mounted as a removable storage medium in the operating system executed by the computing system.

As referenced above, the network controller 108 is configured to provide access to at least one of a wireless network and a wired network. Such a wireless network can be any of the family of IEEE 802.11 networks, or any other wireless network protocol. A wired network can include Ethernet, or any other wired network standard, interface or protocol.

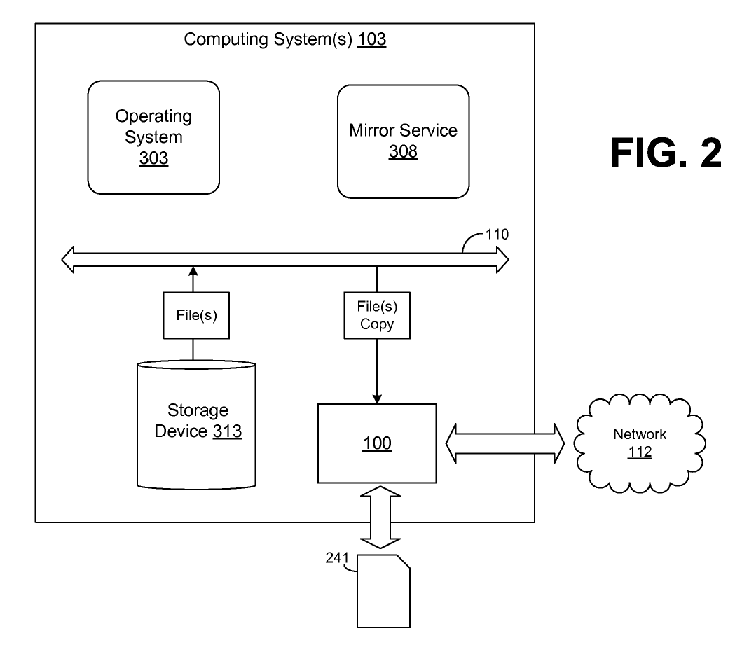

Reference is now made to FIG. 2, which illustrates the various ways in which a CNIS 100 can operate. A computing system 103 may comprise, for example, a processor-based system such as a desktop computer, a laptop computer, personal digital assistants, cellular telephones, smartphones, set-top boxes, music players, web pads, tablet computer systems, game consoles, electronic book readers, or other devices with like capability. The computing system 103 may execute an operating system 303 can manages interactions with a display device as well as other resources accessible to the computing system 103, which can include a network, storage devices 313 such as a hard disk drive, solid state drive, or other mass storage mediums over one or more computing system interfaces 110.

The CNIS 100 can be installed in a computing system via a computing system interface 110 such as a local interface (e.g., Peripheral Component Interconnect, Peripheral Component Interconnect Express, Universal Serial Bus, etc.) and provide access to various types of storage media 241 to a computing system 103. In one embodiment, the CNIS 100 can cause the storage media 241 installed in an access device integrated with or in communication with the CNIS 100 to be mounted by an operating system 303 executed by a computing system 103 as a storage device.

FIG. 2 also illustrates an example of a mirroring service 308 that can be executed by the computing system 103. The logic of the mirroring service 308 can also be integrated into the operating system 303. The mirroring service 308 can allow a user and/or application executed by the computing system 103 to designate certain files, folders, directories, etc., in a storage device 313 to be synchronized or mirrored in the storage media 241. In this way, a user and/or application executed on a client device can access the files via a network 112 that are mirrored on the storage media 241 even if the computing system 103 enters a sleep mode. Accordingly, if a user and/or application adds, deletes, copies, moves and/or modifies a file in the storage device 313, a corresponding change to a copy of the file stored in the storage media 241 can be made by the mirroring service 308. Similarly, if a user changes, adds, and/or deletes a file stored on the storage media 241 a corresponding change can be made in the storage device 313. In some embodiments, the user and/or application can store a file on the storage media 241 without first storing the file in the storage device 313 and employing the mirroring service.

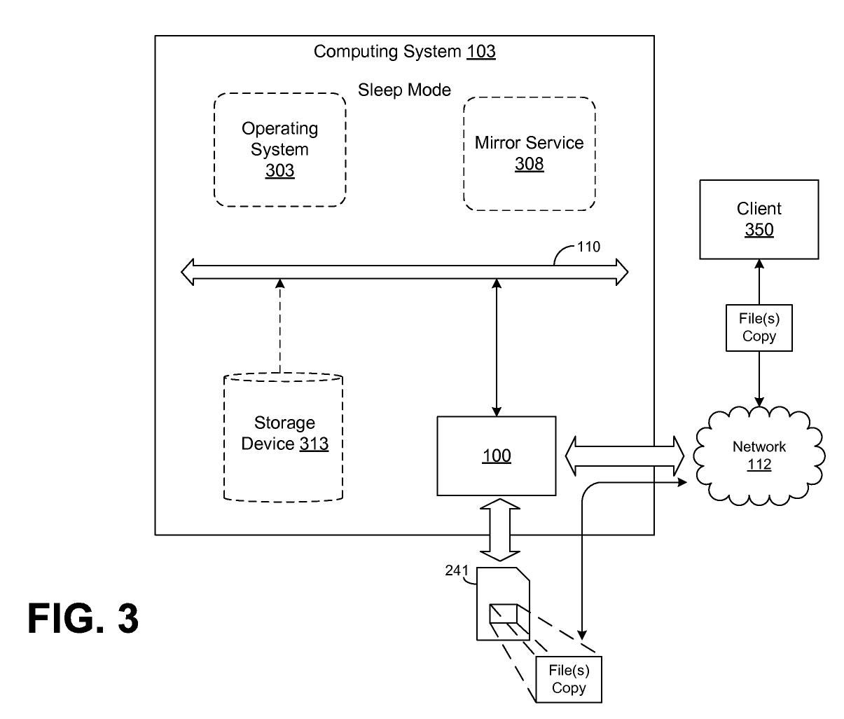

FIG. 3 illustrates one example of the functionality of the CNIS 100 in this regard. In the depicted example, the computing system 103 in which the CNIS 100 is installed has entered a sleep mode. Therefore, the operating system 303, mirroring service 308 as well as storage devices 313 that are installed in the computing system 103 are inaccessible. Accordingly, because the CN IS 100 can draw power from the computing system interface 110, such as an auxiliary power that is provided via the computing system interface 110, and initiate or activate a file system manager as noted above. In some embodiments, the file system manager can be initiated and remain active even when the computing system is not in a sleep mode. In the depicted example, a client device 350, which can include a computing device or system similar in nature to the computing system 103, can access files in the storage media 241 even though the computing system is in a sleep mode via a file server service or protocol executed by the subsystem 114 of the CNIS 100.

In some embodiments, the subsystem 114 can include logic that mirrors a file server protocol executed by the computing system 103 when the computing system 103 is not in a sleep mode. Accordingly, in this way, a user on a client device 350 can access files through a file server protocol executed by the operating system 303 when the computing system is not in a sleep mode and access files on the storage media 241 via the same file server protocol executed by the subsystem 114 when the computing system 103 is in a sleep mode. The subsystem 114 can also mirror authentication credentials, user accounts, and other data so that in this way so that user on a client device 350 can access files synchronized between storage device 313 and/or storage media 241 in a seamless fashion without regard to whether the computing system 103 is in a sleep state.

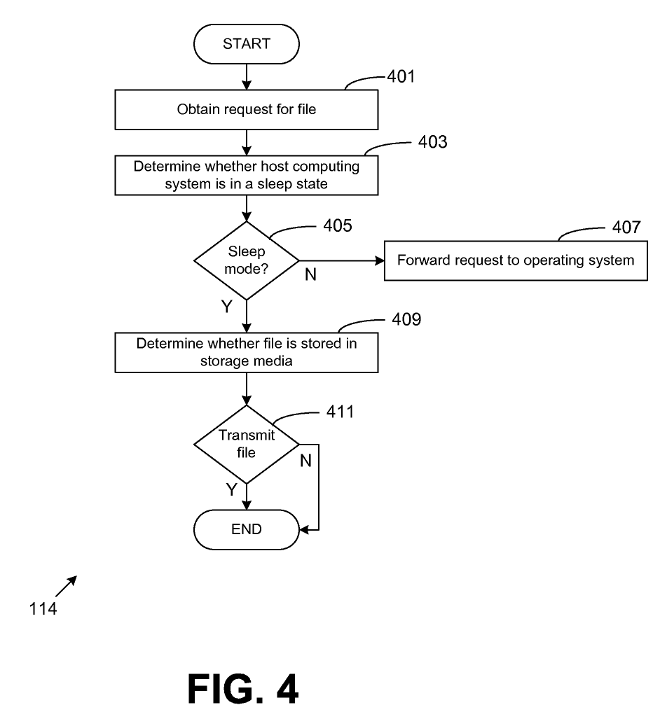

Referring next to FIG. 4, shown is a flowchart that provides one example of the operation of a portion of the subsystem 114 according to various embodiments. It is understood that the flowchart of FIG. 4 provides merely an example of the many different types of functional arrangements that may be employed to implement the operation of the portion of the subsystem 114 as described herein. As an alternative, the flowchart of FIG. 4 may be viewed as depicting an example of steps of a method implemented in the CNIS 100 according to one or more embodiments.

First, in box 401, the subsystem 114 can obtain a request to retrieve a file from a client device via a network to which the CNIS 100 is coupled. In box 403, the subsystem 114 can determine whether a host computing device in which the CNIS 100 is installed is in a sleep or powered off state. If the host computing device is not in a sleep state in box 405, then in box 405, the request can be forwarded to the host operating system, which can service the request.

If the host computing device is in a sleep state, then in box 409, the subsystem 114 can determine whether the requested file is stored in a storage media 241 accessible by the CRHC 119. If the file is accessible in the storage media, then in box 411, the subsystem 114 can transmit the file to the client device via the network interface 116.

The flowchart of FIG. 4 shows the functionality and operation of an implementation of portions of the subsystem 114. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in an embedded system, integrated circuit, or other system. The machine code may be converted from the source code, etc. If embodied in hardware, each block may represent a circuit or a number of interconnected circuits to implement the specified logical function(s).

Although the flowchart of FIG. 4 shows a specific order of execution, it is understood that the order of execution may differ from that which is depicted. For example, the order of execution of two or more blocks may be scrambled relative to the order shown. Also, two or more blocks shown in succession in FIG. 4 may be executed concurrently or with partial concurrence. Further, in some embodiments, one or more of the blocks shown in FIG. 4 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

The various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

Also, any logic or application described herein, including the mirroring service 308, the subsystem 114 or any other components, that comprises software or code can be embodied in any non-transitory computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A system, comprising:
a computing system interface configured to communicate with a local interface of a computing system;
a network controller configured to provide an interface with a network;
a card reader host controller configured to provide an interface with a storage medium, the storage medium storing at least one file; and
a subsystem executed in the network interface controller, the subsystem comprising:
logic that identifies whether a computing system to which the computing system interface is coupled is in a sleep mode;
logic that initiates a file system manager executed in the network interface controller when the computing system is in a sleep mode, the file system manager configured to provide access to the at least one file; and
logic that mounts the storage medium in an operating system executed by the computing system when the computing system is not in a sleep mode.

2. The system of claim 1, wherein the sleep mode is at least one of: a suspended state, a hibernation state, and a standby state.

3. The system of claim 1, wherein the subsystem further comprises logic that initiates drawing power from the computing system interface when the computing system is in the sleep state.

4. The system of claim 1, wherein the file system manager is further configured to implement a file server protocol when the computing system is in a sleep mode, the file server protocol providing access to the at least one file stored in the storage medium via the network by a client device.

5. The system of claim 4, wherein the file server protocol is one of: network file system, common internet file system, and server message block.

6. The system of claim 1, wherein the logic that mounts the storage medium in an operating system executed by the computing system when the computing system is not in a sleep mode further comprises logic that executes a driver supplied by the operating system executed by the computing system, the driver configured to facilitate communication with the card reader host controller via the computing system interface.

7. The system of claim 6, wherein the driver is a universal serial bus mass storage device class driver.

8. The system of claim 1, wherein the computing system interface is at least one of: a universal serial bus interface, a peripheral component interconnect interface and a peripheral component interconnect express interface.

9. The system of claim 1, wherein the logic that determines whether the computing system is in a sleep mode further comprises:
logic that attempts communication with the operating system; and
logic that designates the computing system as in a sleep mode when communication with the operating system fails.

10. The system of claim 1, wherein the logic that determines whether the computing system is in a sleep mode further comprises logic that receives a message corresponding to initiation of a sleep mode from at least one of the operating system and the computing system via the computing system interface.

11. The system of claim 1, wherein the network controller is configured to provide access to at least one of a wireless network and a wired network.

12. The system of claim 1, wherein the storage medium is a flash memory data storage device.

13. A method, comprising the steps of:
identifying, in a combination network interface and storage device, whether a computing system to which a computing system interface of the combination network interface and storage device is coupled is in a sleep mode, the computing system interface being coupled to a local interface of the computing system;
initiating, in the combination network interface and storage device, a file system manager executed in the network interface controller when the computing system is in a sleep mode, the file system manager configured to provide access to at least one file in a storage medium installed in a card reader and accessible by a card reader host controller in the combination network interface and storage device; and
mounting, in an operating system executed by the computing system, the storage medium when the computing system is not in a sleep mode.

14. The method of claim 13, wherein the storage medium further comprises at least one of a removable storage medium and an onboard storage medium.

15. The method of claim 13, wherein the sleep mode is at least one of: an off state, a suspended state, a hibernation state, and a standby state.

16. The method of claim 13, further comprising the step of initiating, in the combination network interface and storage device, the drawing of power from a computing system interface when the computing system is in the sleep state.

17. The method of claim 13, wherein the file system manager is further configured to implement a file server protocol when the computing system is in a sleep mode, the file server protocol providing access to the at least one file stored in the storage medium via the network by a client device.

18. The method of claim 13, wherein the step of determining whether the computing system is in a sleep mode further comprises the step of receiving a message corresponding to initiation of a sleep mode from at least one of the operating system and the computing system via the computing system interface.

19. The method of claim 13, wherein the step of determining whether the computing system is in a sleep mode further comprises:
attempting communication with the operating system; and
designating the computing system as in a sleep mode when communication with the operating system fails.

20. A system, comprising:
means for communicating with a local interface of a computing system;
means for communicating with a network;
means for interfacing with a storage medium storing at least one file;
means for identifying whether a computing system to which the communicating means is coupled is in a sleep mode;
means for providing access to the at least one file when the computing system is in a sleep mode; and
means mounting the storage medium in an operating system executed by the computing system when the computing system is not in a sleep mode.
